(19) United States
(12) Patent Application Publication
(10) Pub. No.: US 2021/0308962 A1
(43) Pub. Date: Oct. 7, 2021

(54) HELICALLY WINDING APPARATUS AND METHOD IN A PRODUCTION LINE FOR MANUFACTURING A NON-METALLIC ARMATURE

(71) Applicant: LIMITED LIABILITY COMPANY "INNOTECH", Moscow (RU)

(72) Inventors: Evgeny Pavlovich ARKHIPOV, g. Rostov-na-Donu (RU); Mikhail Alekseevich PAVLICHENKOV, Moscow (RU); Dmitry Yuryevich DOYKHEN, g. Zhukovskiy (RU); Vadim Davidovich SHTERENLIKHT, Moscow (RU)

(21) Appl. No.: 17/272,976

(22) PCT Filed: Aug. 19, 2019
(86) PCT No.: PCT/RU2019/000585

§ 371 Date: Mar. 3, 2021

(30) Foreign Application Priority Data
Sep. 3, 2018 (RU) 2018131556

(51) Int. Cl. B29C 70/38; B29C 70/86; D01H 1/18; B65H 54/14; B29C 70/52

(52) U.S. Cl. CPC B29C 70/384; B29C 70/86; D01H 1/18; B29L 2023/22; B29C 70/523; B65H 2701/31; B65H 54/14

(57) ABSTRACT

The present invention generally relates to manufacturing of a composite armature, more particularly, to apparatuses for helically winding of a winding roving about a rod when manufacturing a composite armature. There is provided is a helically winding apparatus allowing use of internally unwound roving bobbins instead of sheaves. The helically winding apparatus for a composite armature production line, the apparatus comprising: a disk-shaped creel (1) rotatable about its axis, wherein at least two drums (2) designed to have internally unwound direct roving bobbins mounted therein are mounted on a base of the disk-shaped creel, and each drum is configured to rotate about its axis and to unwind direct roving threads from a bobbin inner side, wherein each drum for placing bobbins of the direct roving is provided with a thread tensioner (3) placed thereon to provide twisting of the direct roving thread relative to its axis when the drum is rotated about its axis to form a twisted roving, wherein the helically winding apparatus further comprises: a cylindrical sleeve (4) positioned in a center of the disk-shaped creel and configured to pass a reinforcement rod through a center of the cylindrical sleeve, wherein the cylindrical sleeve has holes (5) for passing the twisted roving therethrough and helically winding of the twisted roving about the reinforcement rod when the disk-shaped creel is rotated about its axis. A technical effect provided by the claimed invention is an increased produceability of the helically winding apparatus, increased productivity, and a reduced rejection rate.

### BACKGROUND OF THE INVENTION

The present invention generally relates to manufacturing of a non-metallic composite armature, more particularly, to apparatuses for helically winding of a winding roving about a rod when manufacturing the composite armature. There is provided a helically winding apparatus allowing use of internally unwound roving bobbins instead of sheaves.

### DESCRIPTION OF RELATED ART

Known in the art are production lines for manufacturing a non-metallic composite armature, the production lines including the following sequentially arranged components: a rack with roving bobbins; an aligning device; an impregnating bath with a tensioning device; a moulding assembly comprising a thread squeezing assembly; a winding assembly formed as a helically winding apparatus; a polymerization chamber; a cooling assembly; a pulling device; and an armature cord unwinding and cutting unit. The helically winding apparatus is intended to wind a winding roving about a rod of the composite armature.

RU 82247 of Apr. 20, 2009 discloses a helically winding apparatus as a part of a production line for manufacturing a composite armature. The helically winding apparatus of RU 82247 is comprised of a winding disk, wherein at least two coils of a winding cord and a winding sleeve having a cylindrical surface provided with longitudinal T-shaped slots of different length are placed on the winding disk, and a number of slots corresponds to a number of coils of the winding cord. Unwinding of coils is provided from an external side.

A similar construction of the winding assembly (helically winding devices) is known from many other prior art documents, in particular from U.S. Pat. No. 5,811,051 of May 28, 1996.

In the prior art, sheaves having a robing wound thereon or externally unwound roving bobbins are used as coils of the winding assembly.

A disadvantage of such helically winding apparatuses is low produceability. The available technology requires frequent stops of the production line for replacing sheaves or externally unwound roving bobbins, influencing a speed of production of the composite armature and a quality of produced articles. A length of roving threads wound on sheaves is limited and generally in 30-40 times less than that of threads in manufactured internally unwound roving bobbins, and a length of roving threads in manufactured externally unwound roving bobbins is generally in 5-6 times less than that of threads in manufactured internally unwound roving bobbins, so that use of the manufactured internally unwound roving bobbins is more preferable. Manufacturing of externally unwound roving bobbins having greater volume will not provide uniform supply of a thread when manufacturing a composite armature, so that a thread breakage or a nonuniform winding of the rod may be caused, thereby significantly reducing a quality of the produced articles.

Another disadvantage of the technical decision of RU 82247 is low produceability due to sequential mounting of several helically winding apparatuses for forming a winding of the composite armature rod, wherein it makes the technology more difficult and may require more frequent stops of the production line.

An object of the present invention is to provide a helically winding apparatus which would provide an increased produceability due to decreased number of stops of the production line for replacing coils of the winding roving.

### SUMMARY OF INVENTION

In one aspect of the invention, there is provided a helically winding apparatus for a composite armature production line, the apparatus comprising:

a disk-shaped creel rotatable about its axis,

wherein at least two drums designed to have internally unwound direct roving bobbins mounted therein are mounted on a base of the disk-shaped creel, and each drum is configured to rotate about its axis and to unwind direct roving threads from a bobbin inner side,

wherein each drum for placing bobbins of the direct roving is provided with a thread tensioner placed thereon to provide twisting of the direct roving thread relative to its axis when the drum is rotated about its axis to form a twisted roving;

wherein the helically winding apparatus further comprises:

a cylindrical sleeve positioned in a center of the disk-shaped creel and configured to pass a reinforcement rod through a center of the cylindrical sleeve,

wherein the cylindrical sleeve has holes for passing the twisted roving therethrough and helically winding of the twisted roving about the reinforcement rod when the disk-shaped creel is rotated about its axis.

In an embodiment of the helically winding apparatus, each drum is mounted to move relative to at least one another drum to allow braiding of at least two threads of the twisted roving therebetween before winding about the reinforcement rod.

In an embodiment of the helically winding apparatus, the drums for mounting roving bobbins are oriented in parallel to a longitudinal axis of the cylindrical sleeve.

In an embodiment of the helically winding apparatus, the thread tensioner is formed as a standard thread tensioner used in a textile industry.

In an embodiment of the helically winding apparatus, the holes for passing the twisted roving therethrough are positioned uniformly along a periphery of the cylindrical sleeve and symmetrically relative to an axis of passing of the reinforcement rod.

In an embodiment of the helically winding apparatus, a number of the holes in the cylindrical sleeve of the winding roving corresponds to a number of the drums for placing bobbins of the winding roving.

In an embodiment of the helically winding apparatus, a number of the holes in the cylindrical sleeve of the winding roving is less than a number of the drums for placing bobbins of the winding roving.

In another aspect of the invention, there is provided a production line for manufacturing a composite armature, the production line comprising the followings sequentially arranged components: a rack with roving bobbins; an aligning device; an impregnating bath with a tensioning device; a moulding assembly comprising a thread squeezing assembly; a helically winding apparatus; a polymerization chamber; a cooling assembly; a pulling device; and an armature rod unwinding and cutting unit, wherein the helically winding apparatus in the production line comprises a disk-shaped creel rotatable about its axis, wherein at least two drums designed to have internally unwound direct roving bobbins mounted therein are mounted on a base of the disk-shaped creel, and each drum is configured to rotate about its axis and to unwind direct roving threads from a bobbin inner side, wherein each drum for placing bobbins of the direct roving is provided with a thread tensioner to provide twisting of the direct roving thread relative to its axis when the drum is rotated about its axis to form a twisted roving, wherein the helically winding apparatus further comprises a cylindrical sleeve positioned in a center of the disk-shaped creel and configured to pass a reinforcement rod through a center of the cylindrical sleeve, wherein the cylindrical sleeve has holes for passing the twisted roving therethrough and helically winding of the twisted roving about the reinforcement rod when the disk-shaped creel is rotated about its axis.

In still another aspect of the invention, there is provided a helically winding method performed by the helically winding apparatus according to the present invention, the method including helically winding a reinforcement rod with roving threads and further including the following steps:

unwinding direct roving threads from a bobbin inner side of a direct roving secured in a drum mounted on a disk-shaped creel;

wherein, during the unwinding from the bobbin, the direct roving thread is twisted relative to its axis to form a twisted roving;

passing the twisted roving through holes in a cylindrical sleeve positioned in a center of the disk-shaped creel to helically wind the twisted roving about the reinforcement rod passing through a center of the cylindrical sleeve.

In an embodiment of the method, when the direct roving thread is twisted relative to its axis, at least two roving threads therebetween are braided, and then at least two roving threads twisted therebetween are helically wound about the reinforcement rod.

A technical effect provided by the invention is increased produceability of the helically winding apparatus, increased productivity, and a reduced rejection rate. The produceability is provided by using of internally unwound industrial roving bobbins instead of sheaves or externally unwound bobbins, thereby excluding a further step of winding of roving threads from the bobbins to sheaves and reducing a number of stops of the production line for replacing externally unwound bobbins or sheaves. The produceability can be further increased by twisting of two or more roving threads therebetween before winding about the reinforcement rod, so that sequential installation of several helically winding apparatuses in the production line is not required.

### BRIEF DESCRIPTION OF THE DRAWINGS

FIG. 1 shows an illustrative embodiment of the helically winding apparatus.

FIG. 2 schematically shows the helically winding apparatus according to the present invention and its operation diagram.

### DESCRIPTION OF THE PREFERRED EMBODIMENTS

A technology of producing a composite armature is generally well-known for one skilled in the art and, thus, each step of the technology will not be described in details. The technology is based on the «pultrusion»—forming of elongated molded parts due to continuous extending of reinforcing material impregnated with an adhesive, through a heated forming die.

It is to note that the production line may include the following sequentially arranged components: a rack with roving bobbins; an aligning device; an impregnating bath with a tensioning device; a moulding assembly with a thread squeezing assembly; a winding assembly; a polymerization chamber; a cooling assembly; a pulling device; and an armature cord unwinding and cutting unit.

A rack with roving bobbins may be formed, for example, as a row of shelfs where rods are arranged to mount roving bobbins and to allow unwinding of the roving bobbins, for example, by rotation thereof about an axis of the rods.

The rovings can be formed of mineral (glass, basalt, carbon and etc.) or polymer (capron, polyester and etc.) threads.

The aligning device is intended to uniformly supply rovings to the impregnating bath.

The impregnating bath may be provided with a heating element to provide a required temperature impregnation condition. After the impregnating bath rovings enter the moulding assembly.

The moulding assembly may be formed, for example, as one or more dies forming of the composite armature rod with a predetermined profile.

The formed rod of the armature then moves to a winding assembly which is configured to create a periodic profile on a surface of the armature rod, for example, due to helical winding of the roving threads about the rod axis.

The winding assembly can be formed as a helically winding apparatus which is one aspect of the invention.

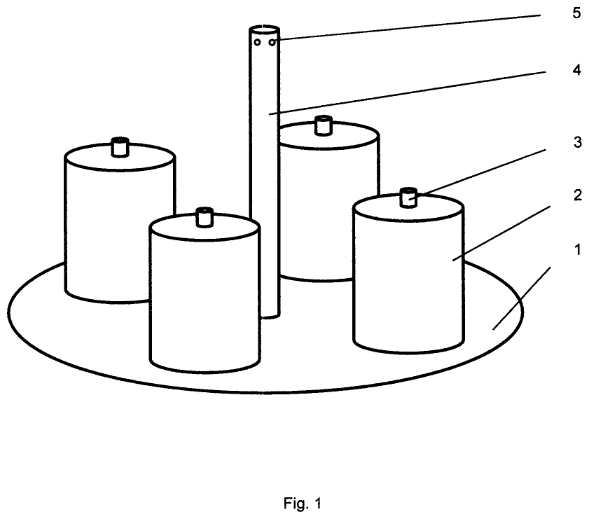

FIG. 1 schematically shows the helically winding apparatus according to the present invention, the apparatus comprising a disk-shaped creel 1 rotatable about its axis. The disk-shaped creel 1 may be driven, for example, by an electric drive (not shown), for example, by a chain or a belt transmission. A particular way to drive the disk-shaped creel 1 is not limited. At least two drums 2 designed to have internally unwound direct roving bobbins mounted therein are mounted on a base of the disk-shaped creel 1.

Although the illustrative example of FIG. 1 shows four (4) drums for mounting roving bobbins, it is evident that, depending on an assigned task, the device may comprise drums for mounting two and more roving bobbins. For example, it can be 2 or 3, or 4, or 5, or 6, or etc. of the drums 2 without imposing restrictions. The drum 2 is configured to rotate about its axis and to unwind direct roving threads from a bobbin inner side. A particular way used to drive the drums 2 is not limited due to, for example, transfer from the rotating of the disk-shaped creel 1 or from a separate drive or drives (not shown). For example, standard industrial bobbins TEX 600, TEX 9600 may be used as internally unwound roving bobbins. A length of roving threads in the bobbin is in the range from 2 km to 40 km, respectively. It is evident that other internally unwound roving bobbins can be used; the above particular examples are not limitations, and only provide better understanding of the scope of the present invention.

Each drum 2 for positioning internally unwound direct roving bobbins is provided with a thread tensioner 3 placed thereon to provide twisting of the direct roving thread relative to its axis when the drum is rotated 2 about its axis (unwinding of the direct roving from the bobbins) to form a twisted roving.

The thread tensioner 3 can be formed as a standard thread tensioner used in a textile industry, the tensioner including: a compensating spring, a bar, and washers (plates). A particular variant of the thread tensioner is a thread tension regulator for the industrial sewing machine «Aurora-8700*02043*229-45356». It is clear that other thread tensioner designs providing twisting of the direct roving when unwinding the direct roving from the bobbin can be used.

A cylindrical sleeve 4 is positioned in a center of the disk-shaped creel 1 and configured to have a reinforcement rod passing therethrough along an axis of the cylindrical sleeve 4. The cylindrical sleeve 4 passes through bases of the disk-shaped creel 1.

The cylindrical sleeve 4 has holes 5 for passing the twisted roving therethrough and helically winding of the twisted roving about the reinforcement rod when the disk-shaped creel 1 is rotated about its axis.

In an embodiment, the drums 2 for mounting roving bobbins are oriented in parallel to a longitudinal axis of the cylindrical sleeve 4. In an alternative embodiment, the drums 2 may be mounted at an angle to a longitudinal axis of the cylindrical sleeve 4.

The holes 5 for passing the twisted roving therethrough are positioned uniformly along a periphery of the cylindrical sleeve 4 and symmetrically relative to an axis of passing of the reinforcement rod.

In an embodiment, a number of the holes 5 in the cylindrical sleeve 4 of the winding roving corresponds to a number of the bobbins of the winding roving and a number of the drums 2, respectively.

In an alternative embodiment, each drum 2 is mounted to move relative to at least one another drum 2 to allow braiding of at least two threads of the twisted roving therebetween before winding about the reinforcement rod. Braiding of two or more threads may be performed based on a principle used for braiding of a rope or twisting of threads therebetween, and allows creating a predetermined winding profile on the reinforcement rod. It allows increasing of the produceability of the helically winding apparatus according to the present invention, wherein sequential installation of several winding assemblies (several helically winding apparatuses) in the production line for manufacturing the composite armature is no longer required.

In case of braiding of two or more threads therebetween a number of the holes 5 in the cylindrical sleeve 4 of the winding roving can be less than a number of the drums for mounting of bobbins of the winding roving.

After the winding assembly, the armature passes through the polymerization chamber where removing of volatile substances and sintering (polymerization) of an adhesive to a one-piece article are performed at a temperature up to 400° C. Heating is performed, for example, by means of a thermoelectric heater or a microwave heater, or an infrared industrial heater-emitter. Once sintering of the armature is finished, the armature is passed through the cooling assembly (where it is cooled to a predetermined temperature), the pulling device, and then armature cord unwinding and cutting unit.

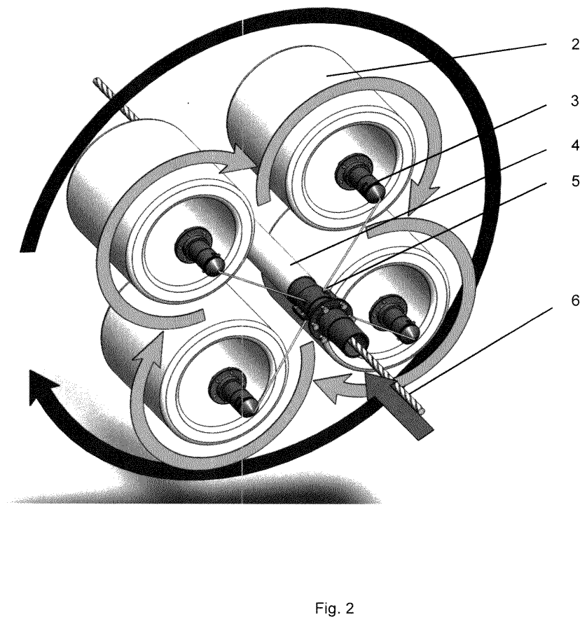

FIGS. 1 and 2 schematically illustrate a helically winding method performed by the helically winding apparatus according to the present invention. The method includes the following main steps:

unwinding direct roving threads from the inner side of bobbins of the direct roving secured within the drums 2 mounted on the disk-shaped creel 1;

wherein, during the unwinding from the bobbins, direct roving threads are twisted relative to its axis by rotating the drums 2 about its axis and by means of thread tensioners 3 to form the twisted roving;

passing the twisted roving through the holes 5 in the cylindrical sleeve 4 positioned in the center of the disk-shaped creel 1 to helically wind the twisted roving about the reinforcement rod 6 passing through the center of the cylindrical sleeve 4. Winding of the twisted roving about the reinforcement rod 6 (winding of the reinforcement rod 6) is performed by rotation of the disk-shaped creel when extending the rod through the cylindrical sleeve 4.

In an embodiment of the method (not shown), if the direct roving thread is twisted relative to its axis, at least two roving threads are braided therebetween, and then the at least two intertwisted roving threads are helically wound about the reinforcement rod.

Disclosed illustrative embodiments, examples and description only serve to provide better understanding of the claimed inventions and the technology and cannot be considered as limitations. Other possible embodiments will be clear for one skilled in the art after reading the above description. A scope of the present invention is limited only by the enclosed claims.

1. A helically winding apparatus for a composite armature production line, the apparatus comprising:
a disk-shaped creel rotatable about its axis,
wherein at least two drums designed to have internally unwound direct roving bobbins mounted therein are mounted on a base of the disk-shaped creel, and each drum is configured to rotate about its axis and to unwind direct roving threads from a bobbin inner side,
wherein each drum for placing bobbins of the direct roving is provided with a thread tensioner placed thereon, and the thread tensioner provides twisting of the direct roving thread relative to its axis when the drum is rotated about its axis to form a twisted roving;
wherein the helically winding apparatus further comprises:
a cylindrical sleeve positioned in a center of the disk-shaped creel and configured to pass a reinforcement rod through a center of the cylindrical sleeve,
wherein the cylindrical sleeve has holes for passing the twisted roving therethrough and helically winding of the twisted roving about the reinforcement rod when the disk-shaped creel is rotated about its axis.

2. The helically winding apparatus according to claim 1, wherein each drum is mounted to move relative to at least one another drum to allow braiding of at least two threads of the twisted roving therebetween before winding about the reinforcement rod.

3. The helically winding apparatus according to claim 1, wherein the drums for mounting roving bobbins are oriented in parallel to a longitudinal axis of the cylindrical sleeve.

4. The helically winding apparatus according to claim 1, wherein the thread tensioner is formed as a standard thread tensioner used in a textile industry.

5. The helically winding apparatus according to claim 1, the holes for passing the twisted roving therethrough are positioned uniformly along a periphery of the cylindrical sleeve and symmetrically relative to an axis of passing of the reinforcement rod.

6. The helically winding apparatus according to claim 1, wherein a number of the holes in the cylindrical sleeve of the winding roving corresponds to a number of the drums for placing bobbins of the winding roving.

7. The helically winding apparatus according to claim 2, wherein a number of the holes in the cylindrical sleeve of the winding roving is less than a number of the drums for placing bobbins of the winding roving.

8. A production line for manufacturing a composite armature, the production line comprising sequentially arranged:
a rack with roving bobbins;
an aligning device;
an impregnating bath with a tensioning device;
a moulding assembly comprising a thread squeezing assembly;
a helically winding apparatus;
a polymerization chamber;
a cooling assembly;
a pulling device; and
an armature rod unwinding and cutting unit,
wherein the helically winding apparatus in the production line comprises a disk-shaped creel rotatable about its axis,
wherein at least two drums designed to have internally unwound direct roving bobbins mounted therein are mounted on a base of the disk-shaped creel, and each drum is configured to rotate about its axis and to unwind direct roving threads from a bobbin inner side,
wherein each drum for placing bobbins of the direct roving is provided with a thread tensioner placed thereon to provide twisting of the direct roving thread relative to its axis when the drum is rotated about its axis to form a twisted roving;
wherein the helically winding apparatus further comprises a cylindrical sleeve positioned in a center of the disk-shaped creel and configured to pass a reinforcement rod through a center of the cylindrical sleeve,
wherein the cylindrical sleeve has holes for passing the twisted roving therethrough and helically winding of the twisted roving about the reinforcement rod when the disk-shaped creel is rotated about its axis.

9. A helically winding method performed by the helically winding apparatus according to claim 1, the method including helically winding a reinforcement rod with roving threads and further including the following steps:
unwinding direct roving threads from a bobbin inner side of a direct roving secured in a drum mounted on a disk-shaped creel;
wherein, during the unwinding from the bobbin, the direct roving thread is twisted relative to its axis to form a twisted roving;
passing the twisted roving through holes made in a cylindrical sleeve positioned in a center of the disk-shaped creel to helically wind the twisted roving about the reinforcement rod passing through a center of the cylindrical sleeve.

10. The method according to claim 9, wherein if the direct roving thread is twisted relative to its axis, at least two roving threads are braided therebetween, and then the at least two intertwisted roving threads are helically wound about the reinforcement rod.
